(19) United States
(12) Patent Application Publication
(10) Pub. No.: US 2014/0129339 A1
(43) Pub. Date: May 8, 2014

(54) Method and Apparatus for Digital Coupon Presentation

(71) Applicant: FORD GLOBAL TECHNOLOGIES, LLC, Dearborn, MI (US)

(72) Inventors: Perry Robinson MacNeille, Lathrup Village, MI (US); Yimin Liu, Ann Arbor, MI (US); Julius Marchwicki, Detroit, MI (US); Scott Burnell, Detroit, MI (US); Edward Wehrman, Dearborn, MI (US); Oleg Yurievitch Gusikhin, West Bloomfield, MI (US); Basavaraj Tonshal, Northville, MI (US)

(73) Assignee: FORD GLOBAL TECHNOLOGIES, LLC, Dearborn, MI (US)

(21) Appl. No.: 13/671,987

(22) Filed: Nov. 8, 2012

(51) Int. Cl. G06Q 30/02

(52) U.S. Cl. CPC G06Q 30/0265
USPC 705/14.62

(57) ABSTRACT

A system includes a processor configured to receive a plurality of media elements including at least one media element containing an interactive advertisement. The processor is further configured to present the media elements to a vehicle occupant. The processor is also configured to receive acquiescence to store a coupon associated with at least one interactive advertisement. Additionally, the processor is configured to instruct storage of the coupon and instruct storage of any events associated with the coupon which may signal a reason to re-present the coupon to a driver.

### TECHNICAL FIELD

The illustrative embodiments generally relate to a method and apparatus for digital coupon presentation.

### BACKGROUND

Advanced content delivery systems and advanced user display systems allow traditional data delivery to take on a whole new aspect. Traditionally, an advertisement may simply come into a vehicle played over a radio. In some cases, the advertisement may be included in a data-stream, connected with delivered content from an alternative source, such as the Internet. Through application of available resources, new and improved advertisement content delivery can be achieved.

U.S. Pat. No. 7,860,450 generally relates to an electronic couponing technique that includes transferring coupon information, which may include a coupon ID (identification) to a first portable terminal and storing same therein. The portable terminal displays a representation of the transferred coupon information on a display thereof. The stored coupon information may be transferred from the portable terminal to another terminal for redemption. The stored coupon information may also be transferred from the portable terminal to another portable terminal. Various schemes may be used to transfer the coupon information including a Bluetooth low-range radio link or an optical bar code scanner scanning an optical bar code or an infrared link or a wireless link from the portable terminal. The Internet or wireless LAN (Local Area Network) may also be used in transferring the coupon information to and from the various terminals.

U.S. Patent Application 2007/0050248 generally relates to a method for utilizing presentation slots to manage advertising and coupon presentation to mobile communication devices over a communication network is stored and executed as an application for use by network devices. The method includes sensing vehicle context and vehicle events, based on vehicle sensor data. Presentation slots, particular circumstances for which advertisements may be presented to a vehicle user, are configured. When a presentation slot is triggered through sensing of a vehicle context or vehicle event, the method identifies advertisements to be presented to the vehicle user, with the advertisements corresponding to configured presentation slots. The identified advertisements are presented to the vehicle user.

Eurpoean Patent Application generally relates to memory mediums storing position data of specific facilities that can be read as position data of a destination on the map data of a vehicle navigation apparatus are distributed to users. When a user sets or inserts this memory medium to a fixed location of the navigation system, the position data of the specific facilities is read and set as the destination. Then the vehicle navigation apparatus starts route guiding to the destination. Arriving at the destination, the user can shop or obtain the benefit of discounts at the facilities (the shop) by using coupons for those shops, also stored on the memory medium.

### SUMMARY

In a first illustrative embodiment, a system includes a processor configured to receive a plurality of media elements including at least one media element containing an interactive advertisement. The processor is further configured to present the media elements to a vehicle occupant. The processor is also configured to receive acquiescence to store a coupon associated with at least one interactive advertisement. Additionally, the processor is configured to instruct storage of the coupon and instruct storage of any events associated with the coupon which may signal a reason to re-present the coupon to a driver.

In a second illustrative embodiment, a system includes a processor configured to receive incoming event notification from at least a vehicle system. The processor is further configured to compare the event notification to a plurality of stored events, relating to one or more saved coupons. Also, the processor is configured to present a saved coupon for redemption, upon a correlation between the event notification and at least one stored event. The processor is further configured to receive an indication that redemption of the saved coupon is desired and provide guidance in redeeming the saved coupon.

In a third illustrative embodiment, a computer-implemented method includes receiving incoming event notification from at least a vehicle system. The method further includes comparing the event notification to a plurality of stored events, relating to one or more saved coupons, using a vehicle computing system. The method additionally includes presenting a saved coupon for redemption, upon a correlation between the event notification and at least one stored event. Also, the method includes receiving an indication that redemption of the saved coupon is desired. The method additionally includes providing guidance in redeeming the saved coupon.

### BRIEF DESCRIPTION OF THE DRAWINGS

FIG. 1 shows an illustrative example of a vehicle computing system;

FIG. 2 shows an illustrative example of a content delivery system;

FIG. 3 shows an illustrative example of a coupon delivery process;

FIG. 4 shows an illustrative example of a further coupon delivery process;

FIG. 5 show an illustrative example of an interactive redemption process;

FIG. 6 shows an illustrative example of a number of processes involved in exemplary coupon delivery;

FIG. 7 shows another illustrative example of a number of processes involved in exemplary coupon delivery;

FIG. 8 shows an illustrative example of a coupon delivery system; and

FIG. 9 shows another illustrative example of a coupon delivery system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

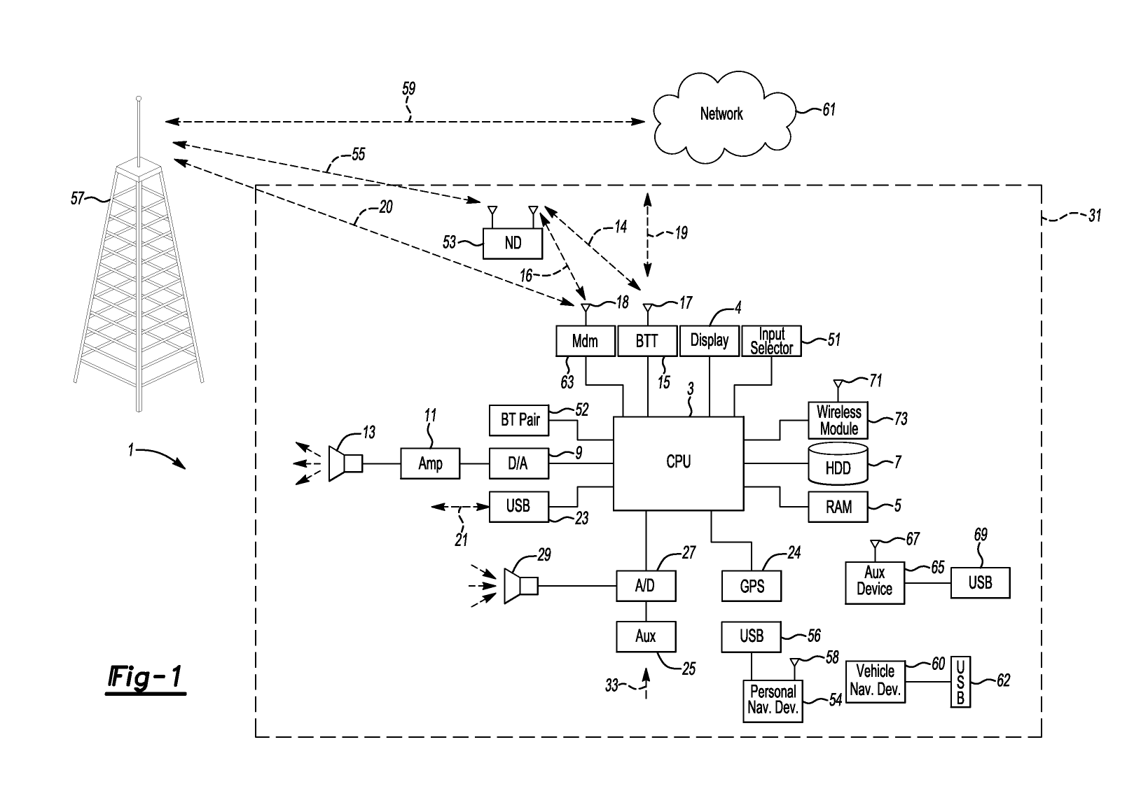

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen.

In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

It is becoming increasingly common for people to utilize streaming content for entertainment purposes. Various services are available for consumption of content through both mobile devices and through other computing systems. In conjunction with this content, the content providers often wish to deliver advertisements to a user. While randomly selected advertisements may have a demographic component, the more information that is available about a user, the better the advertisement selection can be.

At the same time, even using targeted advertisements, there is often very little opportunity to recognize that a user took advantage of a particular offer. Further, it is often difficult to incentivize a user to participate in an offer, unless the advertisement is delivered at a precise time so as to pique a user's interest. Utilizing the illustrative embodiments proposed herein, however, targeted advertisements can be delivered to a user with a relatively high degree of trackability, since the illustrative embodiments also provide for interactive content and possible coupon delivery.

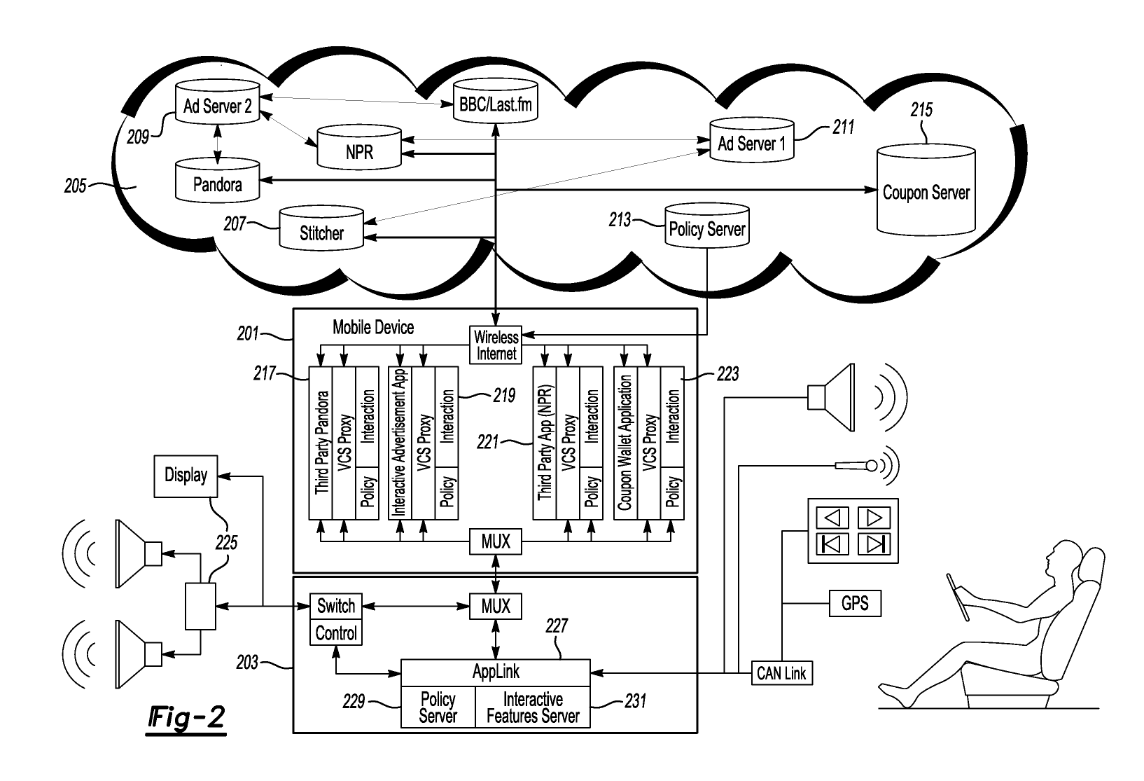

FIG. 2 shows an illustrative example of a content delivery system. In this illustrative example, a number of services run in the cloud 205 to present a variety of content to a vehicle driver. In this example, one or more advertisement servers 209, 211 work in conjunction with a plurality of content provision applications 208 to provide advertisement funded content to a mobile device 201.

In addition, in this model, a coupon server 215 is provided. This server can be maintained by an advertiser, an OEM, a third party, or some combination of these types of parties can maintain one or more advertisement servers. Working in conjunction with a policy server (which may serve to determine that OEM or content-provider specifications are met), advertisements, content, coupons and other media can be provided to the vehicle computing system in a seamless manner.

Running on the mobile device, in this example, are a plurality of applications. These include, but are not limited to, third party content applications 217, 221, advertising applications 219, coupon wallet applications 223 and other suitable applications for content delivery/storage. In the example shown, the content is delivered using wireless internet, but the content could also be delivered in any other suitable manner.

Output from the applications running on the mobile device is combined and sent to a vehicle computing system 203 for delivery to a driver. This content can be processed through an API interface 227, which may include its own policy server access 229 and an interactive features server 231. These two components can server to further enforce OEM policy and provide interactive advertisements to a user through vehicle outputs 225. Responsive to the interactive advertisements, the user can use a variety of inputs (touch screen, steering wheel buttons, radio buttons, voice commands, etc.) to interact with the advertisements in requests for coupon storage, further information, etc.

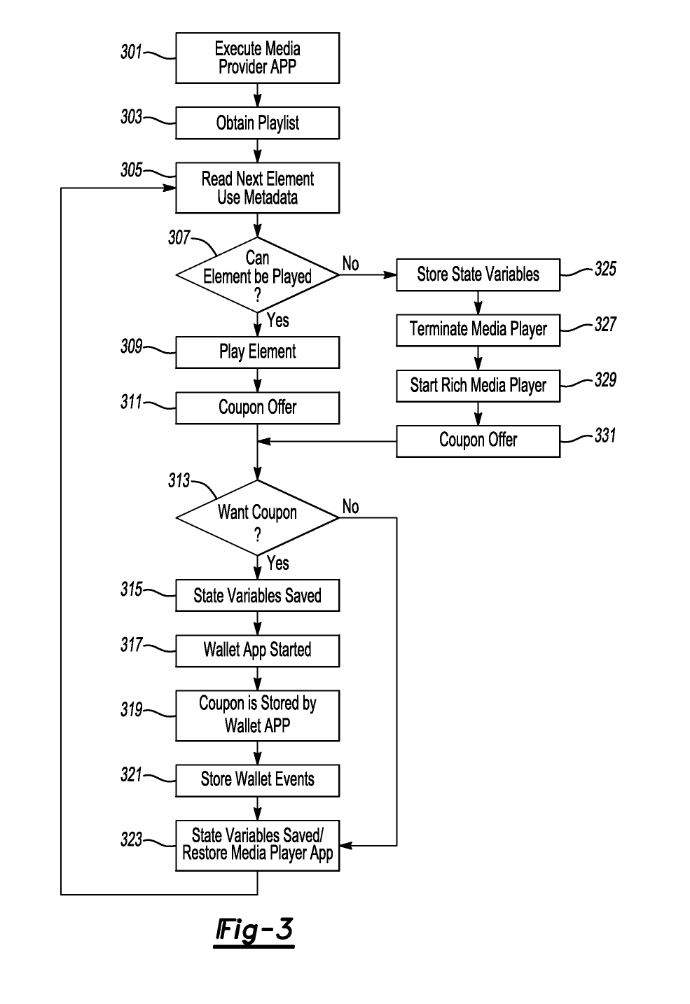

FIG. 3 shows an illustrative example of a coupon delivery process. In this illustrative application, the process shown runs on a mobile device in communication with both the cloud and a vehicle computing system. In this example, a media provider application is executed on the mobile device in order to bring in content from an outside source 301. Following execution of the application, a playlist is obtained from a remote source 303. In this example, the playlist not only includes digital content for user enjoyment, but also a plurality of advertisements, some or all of which may also have interactive content and/or coupons associated therewith.

Once the playlist has been received, the process can read a next element and use any metadata associated therewith to obtain necessary privileges associated with element playback 305. In this illustrative example, the process may then consider if the next element can be played 307. In some instances, content associated with the next element may require an advanced media player or content player, for example, a player capable of video playback or playing interactive content. In such a case, the element may not be playable by a standard content player.

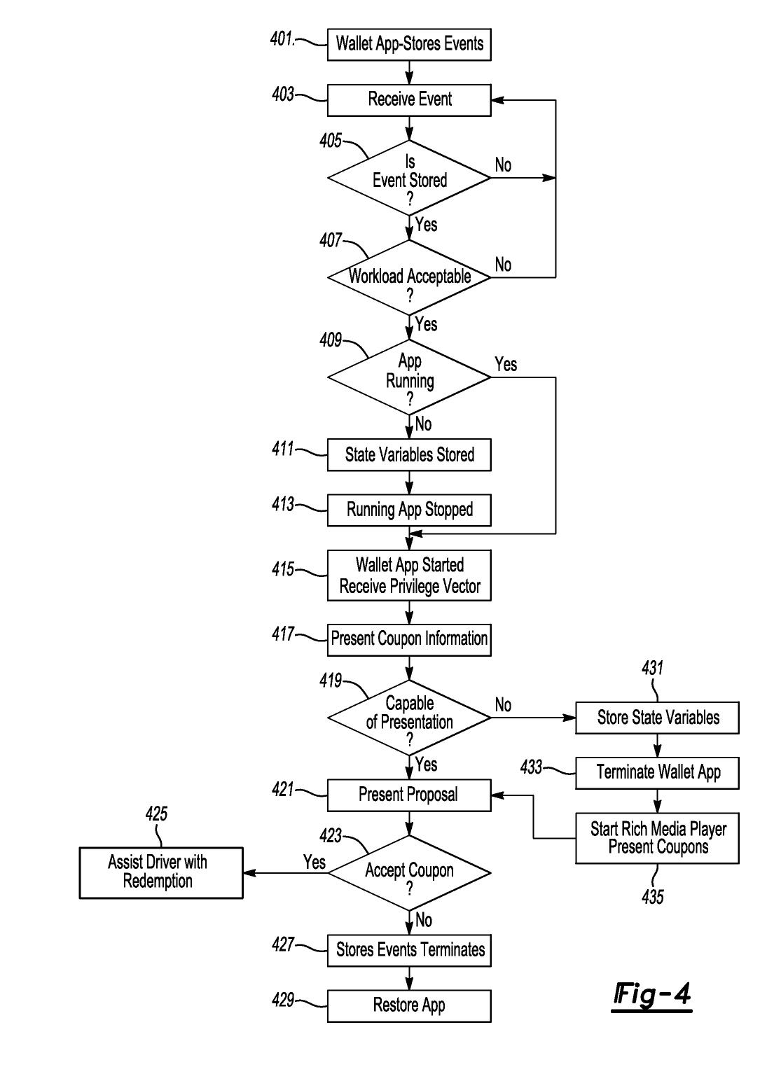

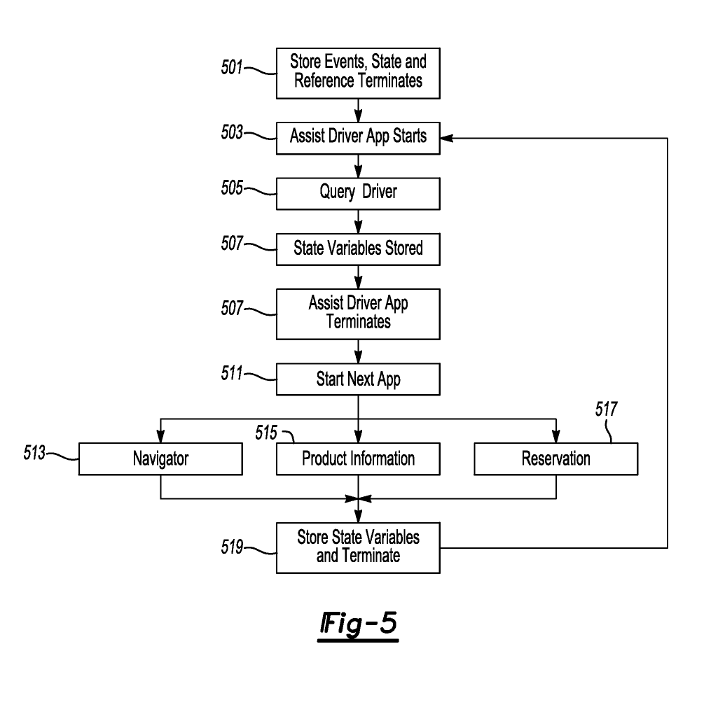

If the element is not playable utilizing the current content player, the process may store any current state variables associated with the current playback (position on list, upcoming media, etc.) 325. Once the current state variables are stored, the process may terminate the current media player 327 and initiate a rich media player 329. The rich media player may provide advanced content playback and may inherit any current state variables to assist the media player in rich content playback. In this case, the advanced content includes a coupon offer 331. Presentation of coupons and redemption/storing thereof is discussed in greater detail with respect to FIGS. 4 and 5.

In the event that the element can be played by the standard media player, the content playback may play the element 309. In some cases, this element may also include a coupon. Coupons can be selectable/storable regardless of content type, although coupons associated with a rich media player may have interactive or advanced media elements associated therewith.

In either instance, once a coupon has been offered, the process also provides a mechanism through which a user can elect to take advantage of a coupon, be it redemption or storage of the coupon. In some other instances, the user may elect to have the coupon delivered to a text account or email address. If the user wants the coupon 313, the process may proceed to save any current state variables for the media playback application 315, and execute a wallet application 317.

In this example, the wallet application is an application that allows storage and future retrieval of coupons presented through the playback of media. Once the user has elected to take advantage of a coupon, or indicated interest, the process may store the coupon in a digital location associated with the wallet application. In addition to the storage of the coupon, any wallet events may also be stored 321, before termination of the wallet application, saving of state variables 323, and restoration of the media player application.

FIG. 4 shows an illustrative example of a further coupon delivery process. In this illustrative example, the process stores wallet application events 401 prior to the termination of the wallet application. In this illustrative example, the process may then receive an event from a driver, a vehicle or an internet server 403. These events include, but are not limited to, arrival of the driver at a specific location, the vehicle passing by a specific location, a time-sensitive activation of a coupon offer, the request of a driver to activate a coupon, etc.

Upon receipt of the event, the process then checks to see if the event that was stored by the wallet application. In other words, events may be broadcast based on the occurrence of certain variable conditions, whether or not the events correlate to an actual wallet application event. In this manner, any event can be compared to stored wallet application events, without having to constantly check variables associated with every users individual wallet application events to determine which events are proper for receipt by that user.

In one example of the above, a user receives two coupons, one for a McDonalds and one for a gasoline offer at a local gas station. The McDonalds coupon may only be good until 11 AM that day, and the offer for the gas station may only be good while a vehicle is in current proximity to a gas station. In such a case, one received event may be from the server, and may be received hourly. If the event that 10 AM was approaching is received, it may not correspond to any stored events, namely “is it 11 AM” and “is the driver still proximate to the gas station.” An hour later, the vehicle may receive the event “11 AM is approaching.” In this case, the correlation exists between the event and the stored wallet event (the expiration of the coupon), so a user may be notified that a coupon must be used or lost.

At the same time these events are being received from a server, the vehicle may be tracking proximity to a gas station. In this case, the event is specific to the user for this instance of the coupon. If the vehicle is approaching or leaving a zone in which the gas station coupon is valid, the user may be notified, based on the occurrence of a vehicle event “proximity reached” or “leaving proximity” that the coupon must be used or lost. Through aggregation of numerous events and their relation or non-relation to existing coupons, users can be encouraged to take advantage of deals at appropriate moments, while not being distracted by the incidences of irrelevant events (which may themselves be triggers for other users having differing coupons).

Once it has been determined that a particular event correlates to a stored wallet event 405, the process then may determine if a current driver workload is acceptable 407. This information can be used to ensure that information relating to offers is delivered to drivers at appropriate moments, where they are unlikely to be ignored or otherwise not be of interest to a driver. If both the event and the driver workload are acceptable, the process may proceed to determine if any other application is currently running. In some mobile environments, only a single application can be run at a time, so when a new application is initiated the process saves the state of the old application so that the old application can be re-initiated when the new application has ended.

If a current application is running 409, the process may save any state variables associated with that application 411 and terminate the currently running application 413. At this point, the wallet application can be started 415. Since the wallet application may need to be started at any moment, it may be useful to provide this process to “interrupt” another application, while still providing for the revival of the application once the interruption has completed.

The wallet application is started and appropriate privileges are assigned to the wallet application 415. In conjunction, the appropriate coupon, as indicated, for example, by the particular event, is presented to a user for redemption 417. If the coupon has rich media associated therewith, and is not presentable using a common media player associated with the wallet application, the process may store the wallet application state variables 431 and terminate the wallet application 433.

The rich media player can then be started, and use the stored state variables to present the coupon from the terminated wallet application 435. Otherwise, the coupon may simply be presented through the wallet application 421 for user redemption or notification.

If the user elects to utilize the coupon 423, a process may ensue that assists a driver with coupon redemption 425. This process is discussed in more detail with respect to FIG. 5. Otherwise, the process may store the event and any other related wallet events (perhaps the coupon has a “second chance” event when a first redemption option is ignored) and then terminates the wallet application 427. At this point, the originally running application (if any) is restored to its original state using the stored state variables 429.

FIG. 5 show an illustrative example of an interactive redemption process. In this illustrative example, a driver assistance application activates to assist a driver with the redemption of a selected offer. As with the initiation of other applications, storage of state variables and termination of a currently running application 501 (such as the wallet application) can result at the initiation of the redemption application 503.

In this example, the process may then query a driver as to what sort of assistance (if any) is needed for redemption of a coupon 505. This could include, but is not limited to, directions, additional product information, reservations for redemption of a coupon (recharger reservations, restaurant reservations, etc.). After determining what sort of assistance is needed, it may be necessary to start another application to assist with the particular assistance requested.

If a new application is to be started, the process stores any state variables 507 that may be useful for the next application to be launched. These can include addresses, business information, etc. The process then terminates the assistance application 509 and starts the application necessary to provide driver assistance 511 (assuming that the driver application is not sufficient for providing assistance).

Three non-limiting examples of driver assistance applications are discussed here, but additional applications can also be initiated as needed. In this case, the exemplary applications are a navigation application 513, a product information application (or media event) 515 and a reservation making application 517. The navigation application can utilize stored state information to help guide a user to a destination where a coupon can be redeemed. The product information application can provide additional information for a user and, in some instances, even assist in ordering a product available from an online source. The reservation making application can assist a user in selecting a time/date for a reservation and contact the appropriate entity to place the reservation.

Once the particular assistance application has terminated and completed assisting the user, state variables can again be stored and the application can terminate. Through storage of certain state variables throughout the process of launching various applications, the processes described herein can effectively pass information as needed from one application to another, while additionally restoring a system to any original state before these applications were launched. This can provide a seemless interaface between applications such that the driver experiences the process as though a single application were executing the entire process. Of course, if desired, a single application can also be used. The controlling processes described in FIGS. 3-5 can be executed on a vehicle computing system, in the cloud, or on a mobile device, as appropriate and where capabilities permit.

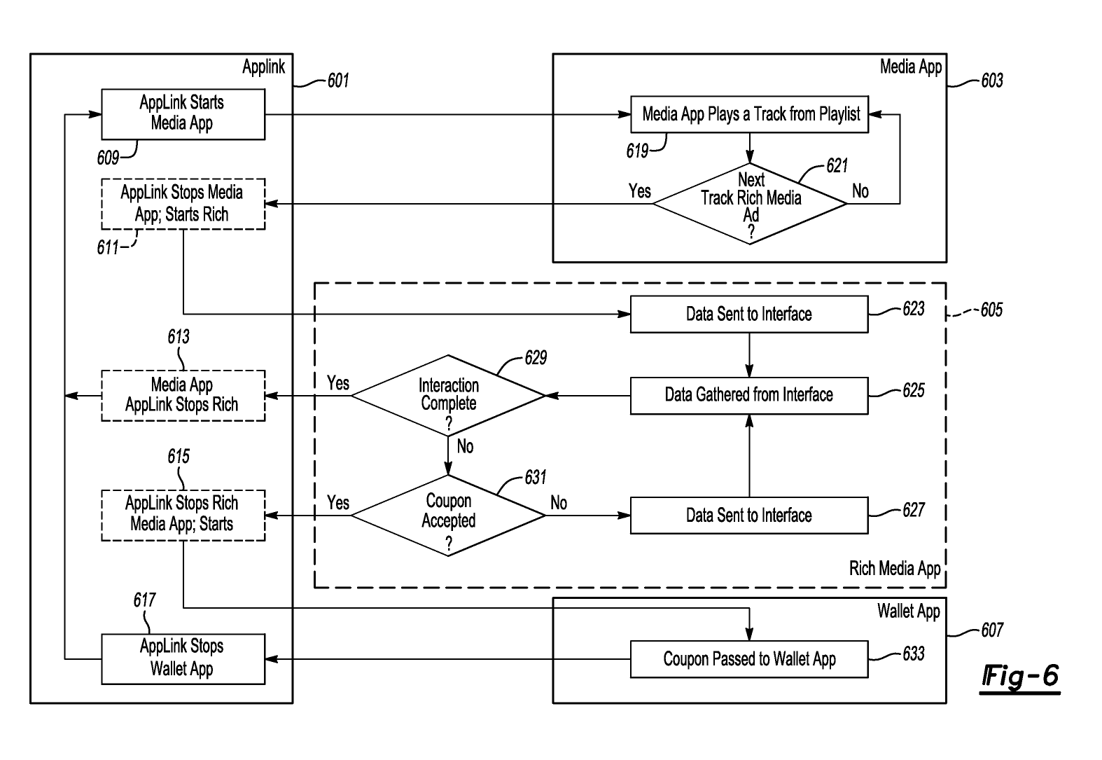

FIG. 6 shows an illustrative example of a number of processes involved in exemplary coupon delivery. In this illustrative example, a process running on a vehicle computing system utilizes an API known as applink 601 to initiate the media presentation process. Applink starts the media application 609, which may, for example, be requested from a driver through a vehicle computing system providing access to a number of applications running on a mobile device.

In response to the request, a media application 603 plays a number of tracks from a playlist 619 until a rich media advertisement is encountered as a next-item on the playlist 621. Once the advertisement is encountered, applink ceases playback of the media items and stops the media application, and starts a rich media player 611 for playback of the rich media advertisement. The rich media application (player) 605 sends interactive media data to a driver interface 623, such as, but not limited to, an interactive navigation display. Driver responses are then gathered from the interface or other inputs 625, and the application determines if driver interaction is complete 629.

In some cases the interaction may cease without presentation of a coupon, such as in the case of an interactive advertisement without an offer associated therewith. In these cases, when the interaction is complete, applink will terminate the rich media player 615 and initiate the media application 609 for resumed media playback. In other cases, if a coupon is presented prior to completion of interaction, the process may determine if a coupon has been accepted 631. If the coupon is not accepted and the interaction is not over, it may be the case that the interaction is ongoing and that a coupon may or may not still be presented. In this case, the data presentation 627 and gathering continues until an exit point is reached.

If the coupon is accepted by the driver, in this example, it means that the interactive session is over. As such, applink terminates the rich media player application and starts a wallet application 615. The wallet application 607 has the coupon and any associated events passed thereto 633. After storing the coupon and the events (if any) associated with the coupon, applink terminates the wallet application 617 and resumes the media player application. In this example, applink assists in the storage of state variables and the passing of state variables from one application to another. For example, it may be the case that a media provider will require four advertisements per hour, or only two advertisements per hour if coupons are accepted/used. Since applink knows and passes the variables from each application, the media player application can be informed of the storage/use of a wallet application coupon, and thus adjust the amount of delivered content in relation to delivered advertisements.

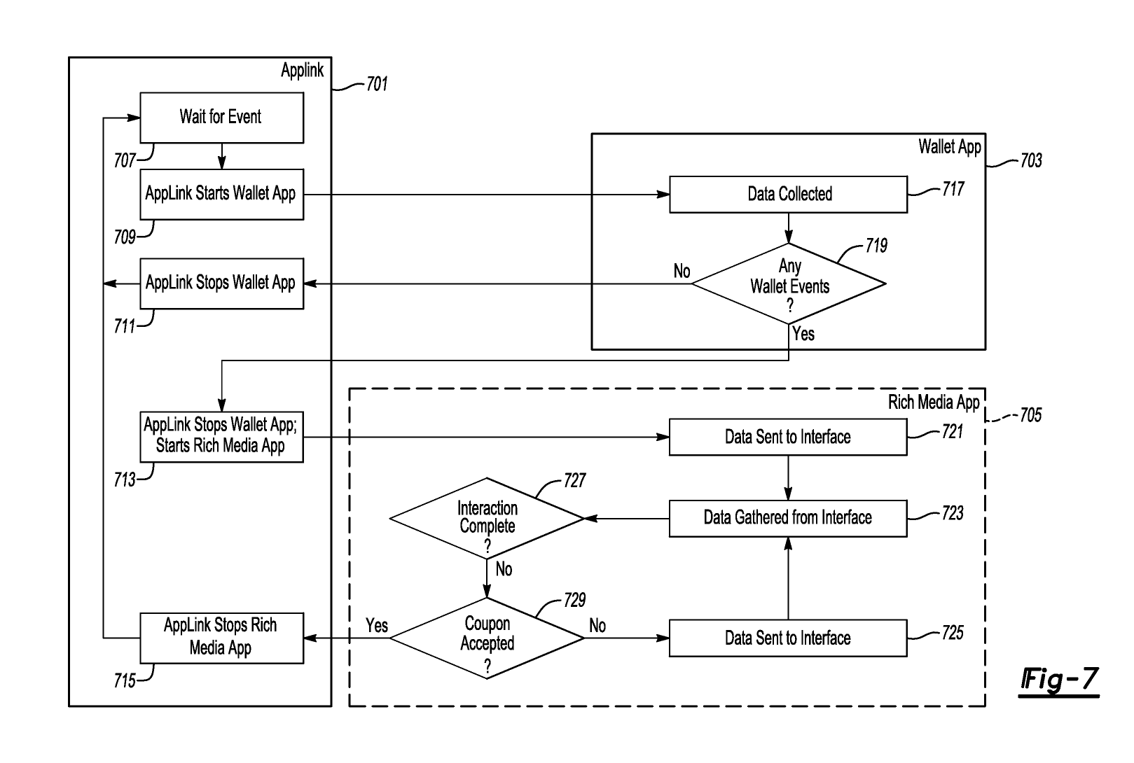

FIG. 7 shows another illustrative example of a number of processes involved in exemplary coupon delivery. In this example, the processes relate to the incidence of one or more events that may trigger a suggestion to redeem a coupon. Again, in this non-limiting example, a process running on a vehicle computing system utilizes applink 701 to control launching and closing of applications running on a mobile device. As with the previously described processes this functionality can be done in the cloud or on a mobile device as desired and appropriate.

In this illustrative example, the process running on the VCS waits until an event is registered 707. As previously described, these events may correlate to events stored by a wallet application in conjunction with certain coupons. In this exemplary process, once an event has been detected, applink may start the wallet application 709. The wallet application 703 can, once activated, collect any necessary data 717 to determine if the conditions of the occurring event meet the conditions of any stored events. This data can result from secondary event modifiers and is virtually limitless, bounded only by the application's collection abilities (and those of resources with which the application communicates).

Once the secondary data has been collected (if needed), the wallet application determines if the current event correlates to any events stored by the wallet application 719. If there is no coincidence of events, applink may terminate the wallet application 711 and wait for another event to occur.

If there is a correlation between the current event and a stored media event, applink may stop the wallet application and launch a rich media application 713, for presentation/representation of the coupon associated with the correlating event. Applink launches the rich media application, and the rich media application then sends coupon related data to a system output for the user to review 721.

The coupon may have some interaction associated therewith, and so, in this case, the process may proceed through the interaction process 727, 723, 725 until all relevant interaction 723 and data presentation 725 is completed 727. At this point, the process continues until the coupon is accepted 729. Although not shown, the process could also terminate if the coupon is rejected following presentation.

Once the coupon has been accepted, the applink may stop the rich media application 715 and wait for another event to occur. As previously noted, applink may also launch one or more driver assistance applications to assist a driver in redemption of a coupon if needed.

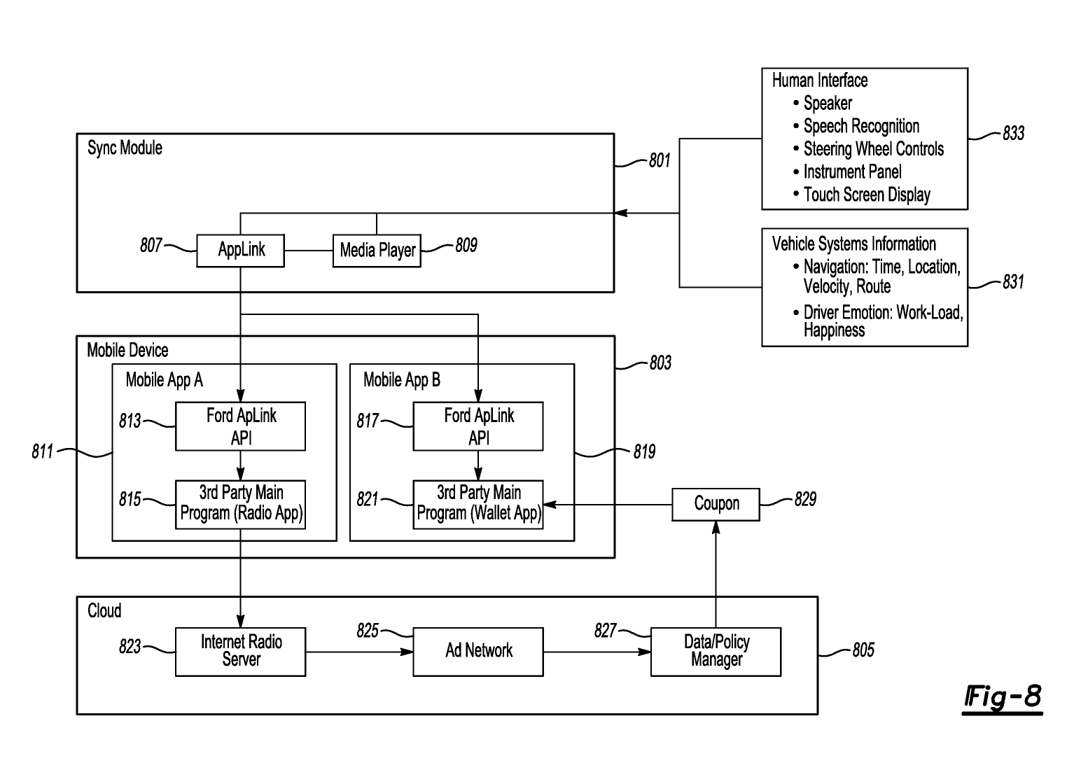

FIG. 8 shows an illustrative example of a coupon delivery system. In this illustrative example, a VCS module 801 contains a media player application controlled by user inputs 833 and possibly responsive to vehicle information 831. The media player and the VCS communicate with a mobile device 803. Specifically, through applink 807, the VCS can communicate with and control various applications 811, 819 running on the mobile device.

In this instance, the mobile applications include both applink interfaces 813, 817 and the code associated with each individual application 815, 821. Also, in this application, the cloud is running a variety of media applications 823, 825 and a policy manager 827. A coupon 829 can be presented to the wallet application, and this process can be controlled overall by a process running on the cloud, mobile application or VCS.

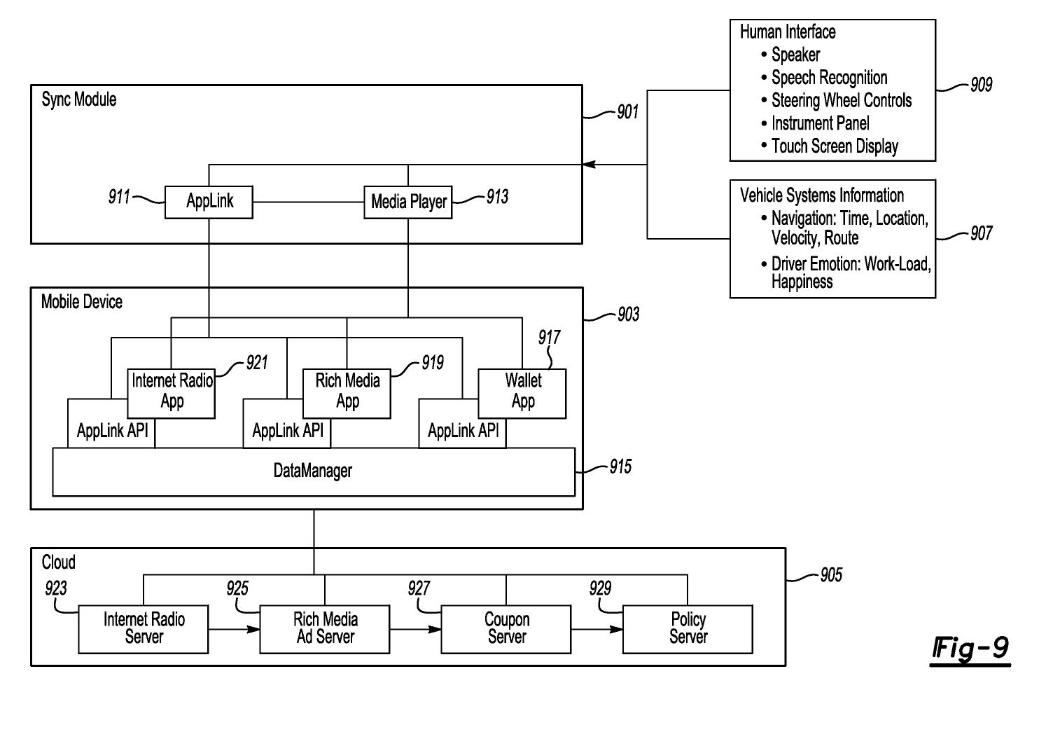

FIG. 9 shows another illustrative example of a coupon delivery system. In this illustrative example, a variety of inputs 909 and data sources 907 are again available. Here, in this example, the VCS has both the media player 913 and the applink 911. In this instance, applink communicates with the mobile device through a data manager 915. The media player communicates with the applications 921, 919, 917 directly.

The cloud 905, in this example, contains media servers 923, 925, a coupon server 927 and a policy server 929. Information passes from the cloud to the mobile device through a variety of sources.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a plurality of media elements including at least one media element containing an interactive advertisement;
present the media elements to a vehicle occupant;
receive acquiescence to store a coupon associated with at least one interactive advertisement;
instruct storage of the coupon; and
instruct storage of any events associated with the coupon which may signal a reason to re-present the coupon to a driver.

2. The system of claim 1, wherein the processor is further configured to, upon receiving a media element containing an interactive advertisement, instruct termination of a standard media player process and instruct initiation of an enriched content media player process.

3. The system of claim 2, wherein the processor is further configured to restore the standard media player process to a pre-termination state upon cessation of the enriched content media player process.

4. The system of claim 1, wherein the processor is further configured to receive notification of an event that may correspond to one or more stored events.

5. The system of claim 4, wherein the notification may come from a remote server.

6. The system of claim 4, wherein the notification may come from a vehicle system.

7. The system of claim 4, wherein the notification may come from a driver.

8. The system of claim 4, wherein the processor is further configured to compare the event to one or more stored events in order to determine if a coupon associated with one of the stored one or more events should be re-presented to the driver.

9. The system of claim 8, wherein the processor is further configured to re-present the coupon to the driver and offer a driver assistance in redeeming the coupon.

10. The system of claim 9, wherein the processor is further configured to offer a driver navigation assistance useful in redeeming the coupon.

11. The system of claim 9, wherein the processor is further configured to offer a driver reservation assistance useful in redeeming the coupon.

12. The system of claim 9, wherein the processor is further configured to offer a driver informational assistance useful in redeeming the coupon.

13. A system comprising:
a processor configured to:
receive incoming event notification from at least a vehicle system;
compare the event notification to a plurality of stored events, relating to one or more saved coupons;
upon a correlation between the event notification and at least one stored event, present a saved coupon for redemption;
receive an indication that redemption of the saved coupon is desired; and
provide guidance in redeeming the saved coupon.

14. The system of claim 13, wherein the processor is further configured to receive incoming event notification from at least a remote server.

15. The system of claim 13, wherein the processor is further configured to receive incoming event notification from at least a vehicle occupant.

16. The system of claim 13, wherein the guidance includes navigation assistance useful in redeeming the coupon.

17. The system of claim 13, wherein the guidance includes reservation assistance useful in redeeming the coupon.

18. The system of claim 13, wherein the guidance includes informational assistance useful in redeeming the coupon.

19. A computer-implemented method comprising:
receiving incoming event notification from at least a vehicle system;
compare the event notification to a plurality of stored events, relating to one or more saved coupons, using a vehicle computing system;
upon a correlation between the event notification and at least one stored event, presenting a saved coupon for redemption;
receiving an indication that redemption of the saved coupon is desired; and
providing guidance in redeeming the saved coupon.
